(19) United States
(12) Patent Application Publication
(10) Pub. No.: US 2007/0245313 A1
(43) Pub. Date: Oct. 18, 2007

(54) Failure tagging

(75) Inventors: Donald G. Hardy, Seattle, WA (US); Alan T.B. Brown, Ellensburg, WA (US); Curtis D. Anderson, Kent, WA (US); Jared W. Wilson, Sammamish, WA (US); Loren J. Merriman, Duvall, WA (US); Richard L. Wright, Redmond, WA (US); Xun Zhang, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/404,679

(22) Filed: Apr. 14, 2006

(51) Int. Cl. G06F 9/44

(52) U.S. Cl. 717/124

(57) ABSTRACT

Failure tagging may be provided. A plurality of tests may be initiated on a program module and output resulting from the plurality of tests may be received. The output resulting from the plurality of tests may be determined to comprise at least one failure. The at least one failure may comprise an unknown failure or a known failure. Results of the plurality of tests indicating the failure may be transmitted. In addition, a request to stop one or more of a plurality of computers on a failure may be received when one of the plurality of computers encounters the failure. In addition, the program module may be transmitted to the plurality of computers configured to run tests on the program module. The one of the plurality of computers may be stopped on the failure when the one of the plurality of computers encounters the failure identified by the request.

### BACKGROUND

Failure tagging is a process for identifying and determining failure causes in software programming modules. It is important for software developers and testers to identify test failure causes in order to correct these failures. With conventional systems, in many cases, failure cause information provided is not comprehensive enough to successfully identify a test failure's root cause. In other words, the failure cause information provided by conventional systems may not allow software developers and testers to correct these failures even though developers and testers may be aware that a problem may exist.

Furthermore, in some situations, failures may be extremely difficult to reproduce during the software programming module testing process due to a specific failure's intermittent nature. For example, conventional systems do not address the issue where a software programming module may not fail during some test execution and yet may fail during other test executions. Thus, the conventional strategy may not address software programming module intermittent failures consistently. This often causes problems because the conventional strategy does not provide a consistent way for developers (and testers), for example, to mark or tag specific failures of interest, and specify actions to take when such failures are encountered during the testing process.

### SUMMARY

Failure tagging may be provided. This Summary is provided to introduce a selection of concepts in a simplified form that are further described below in the Detailed Description. This Summary is not intended to identify key features or essential features of the claimed subject matter. Nor is this Summary intended to be used to limit the scope of the claimed subject matter.

In accordance with one embodiment, a computer-readable medium is provided which stores a set of instructions which when executed performs a method for providing failure tagging. The method executed by the set of instructions may comprise initiating a plurality of tests on a program module and receiving output resulting from the plurality of tests. In addition, the method executed by the set of instructions may include determining that the output resulting from the plurality of tests comprises at least one failure. The at least one failure may comprise one of an unknown failure and a known failure. Then the method executed by the set of instructions may include transmitting results of the plurality of tests, the results indicating the failure.

According to another embodiment, a system for providing failure tagging may comprise a memory storage and a processing unit coupled to the memory storage. The processing unit may be operative to receive a request to stop a one of a plurality of computers on a failure when the one of the plurality of computers encounters the failure, the request identifying the failure. In addition, the processing unit may be operative to transmit a program module to the plurality of computers configured to run tests on the program module. Moreover, the processing unit may be operative to stop the one of the plurality of computers on the failure when the one of the plurality of computers encounters the failure identified by the request.

In accordance with yet another embodiment, a method for providing failure tagging may comprise receiving a program module change notification in response to a change in programming code corresponding to a program module. In addition, the method may include obtaining the program module associated with the program module change notification. Moreover, the method may comprise initiating a plurality of tests on the program module and receiving output resulting from the plurality of tests. Furthermore, the method may include determining that the output resulting from the plurality of tests comprises at least one failure. The at least one failure may comprise one of an unknown failure and a known failure. In addition, the method may include transmitting results of the plurality of tests, the results indicating the failure.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of a failure tagging system;

FIG. 2 is a block diagram of a system including a computing device;

FIG. 3 is a flow chart of a method for providing failure tagging;

FIG. 4 shows a screen shot illustrating a sample results including known failures; and

FIG. 5 shows a screen shot illustrating additional details regarding a corresponding known failure from FIG. 4.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

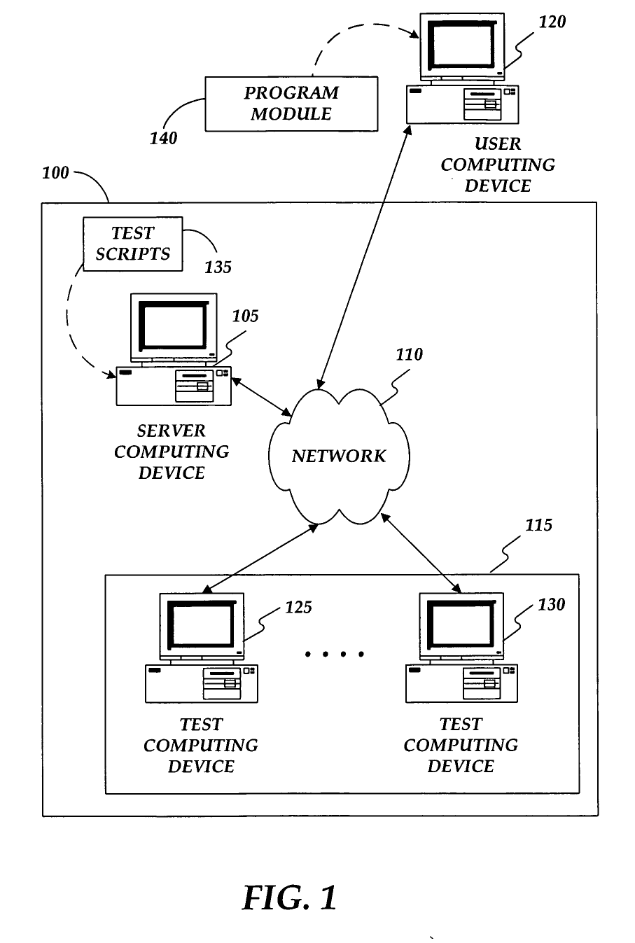

Failure tagging may be provided. For example, embodiments of the invention may identify and annotate failures in an automation failure tagging system. FIG. 1 is a block diagram of a failure tagging system 100 consistent with an embodiment of the invention. System 100 may include a server computing device 105, a network 110, and a plurality of test computing devices 115. Server computing device 115 may communicate with a user computing device 120 over network 110. Plurality of test computing devices 115 may include, but is not limited to, test computing devices 125 and 130. In addition, plurality of test computing devices 115 may comprise a plurality of test computing devices in, for example, a test laboratory controlled by server computing device 105. Plurality of test computing devices 115 may each have different microprocessor models and/or different processing speeds. Furthermore, plurality of test computing devices 115 may each have different operating systems and test components.

Server computing device 105 may include a plurality of test scripts 135. Test scripts 135 may comprise computer programming modules comprising code configured to test, for example, a computer program module 140 without human intervention. For example, a tester may load program module 140 from user computing device 120 to test computing device 125. In addition, the tester may load one of test scripts 135 on to test computing device 125. Once loaded, one of test scripts 135 may be executed on test computing device 125 in order to test computer program module 140.

For example, one of test scripts 135 may test a saved dialogue in computer program module 140 comprising a word processing program. During testing, one of test scripts 135, for example, may function as a user. In other words, one of test scripts 135 may open the word processing program, create a document, and then save the created document. One of test scripts 135 may then report whether the test passed or a failed. In another embodiment, several or all of test scripts 135 may be selected and run on program module 140. If a failure is encountered, the message reported by the test script may comprise a starting point for a developer to investigate that failure. The failure, for example, may be the result of a bug found in program module 140. By identifying the failure, the bug may be fixed by the developer to improve program module 140. Furthermore, by tagging certain failures, when these failures are encountered again or when encountered by other users, the tag may indicate that the failure is known and that corrective actions are being taken by a developer. Consequently, because the testing may be automated, a high testing volume may be performed without a human having to test all the features in program module 140 over and over to see if the features work throughout program module 140's product cycle.

As stated above, embodiments of the invention may provide the ability to tag (i.e. identify and annotate) failures in an automation system. Consistent with embodiments of the present invention, the user may flexibly express a failure tag's scope. For example, the user may provide a specific test scripts for a test or may specify the test for all predefined scenarios. Also, when the user expresses the failure tag's scope, the user may specify using standard SQL wildcards (e.g., *, _, and set notation). In addition, Standard Regular Expression logic found in non-SQL programming languages may be used. In addition, the user may have the ability to hold a machine running a test at a failure point. Other operations may be supported, for example, for known “automation issues” the failure can be re-run, but limit the set of “actions” based on need. Furthermore, consistent with embodiments of the invention, failure tags may be provided a lifecycle. For example, failure tags may be configured to expire after a period of time or may only apply to certain versions of the product. This may encourage users to keep failure tags up to date. Moreover, embodiments of the invention may allow users to retroactively tag failures matching a particular failure tag's criteria to aid in general failure investigation by other users of the automation system.

Network 110 may comprise, for example, a local area network (LAN) or a wide area network (WAN). Such networking environments are commonplace in offices, enterprise-wide computer networks, intranets, and the Internet. When a LAN is used as network 110, a network interface located at any of the computing devices may be used to interconnect any of the computing devices. When network 110 is implemented in a WAN networking environment, such as the Internet, the computing devices may typically include an internal or external modem (not shown) or other means for establishing communications over the WAN. Further, in utilizing network 110, data sent over network 110 may be encrypted to insure data security by using encryption/decryption techniques.

In addition to utilizing a wire line communications system as network 110, a wireless communications system, or a combination of wire line and wireless may be utilized as network 110 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The computing devices in the wireless environment can be any mobile terminal, such as the mobile terminals described above. Wireless data may include, but is not limited to, paging, text messaging, e-mail, Internet access and other specialized data applications specifically excluding or including voice transmission. For example, the computing devices may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

An embodiment consistent with the invention may comprise a system for providing failure tagging. The system may comprise a memory storage and a processing unit coupled to the memory storage. The processing unit may be operative to initiate a plurality of tests on a program module and to receive output resulting from the plurality of tests. In addition, the processing unit may be operative to determine that the output resulting from the plurality of tests comprises at least one failure. The at least one failure may comprise one of an unknown failure and a known failure. Furthermore, the processing unit may be operative to transmitting results of the plurality of tests, the results indicating the failure.

Another embodiment consistent with the invention may comprise a system for providing failure tagging. The system may comprise a memory storage and a processing unit coupled to the memory storage. The processing unit may be operative to receive a request to stop a one of a plurality of computers on a failure when the one of the plurality of computers encounters the failure, the request identifying the failure. In addition, the processing unit may be operative to transmit a program module to the plurality of computers configured to run tests on the program module. Moreover, the processing unit may be operative to stop the one of the plurality of computers on the failure when the one of the plurality of computers encounters the failure identified by the request.

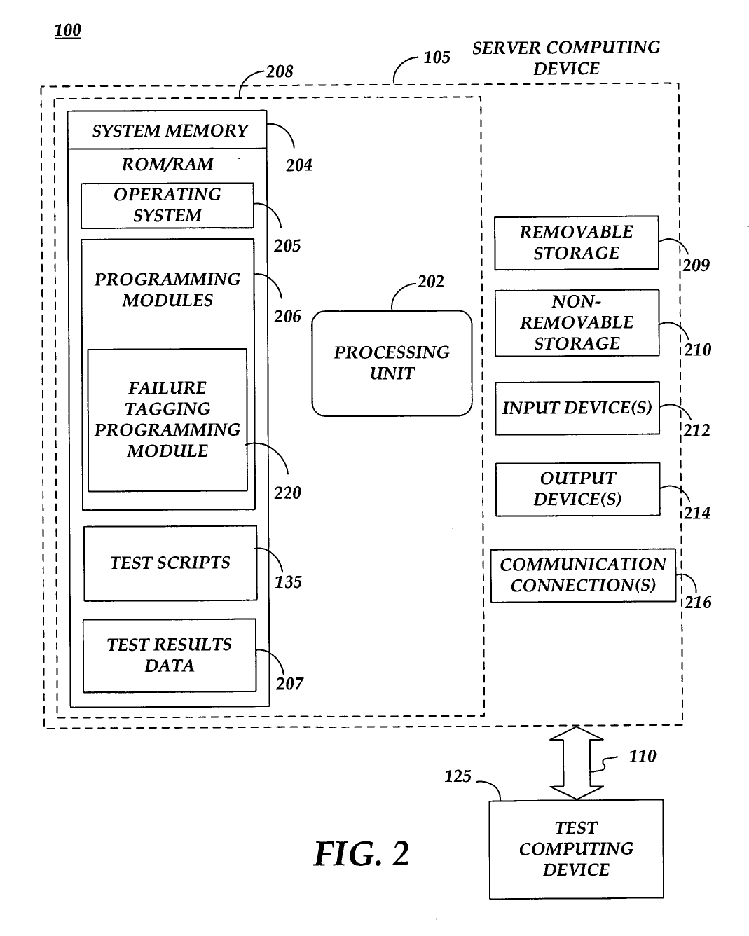

FIG. 2 is a block diagram of a system including server computing device 105. Consistent with an embodiment of the invention, the aforementioned memory storage and processing unit may be implemented in a computing device, such as server computing device 105 of FIG. 2. Any suitable combination of hardware, software, or firmware may be used to implement the memory storage and processing unit. For example, the memory storage and processing unit may be implemented with server computing device 105 or any of test computing devices 115, in combination with server computing device 105. The aforementioned system, device, and processors are examples and other systems, devices, and processors may comprise the aforementioned memory storage and processing unit, consistent with embodiments of the invention.

With reference to FIG. 2, a system consistent with an embodiment of the invention may include a computing device, such as server computing device 105. In a basic configuration, server computing device 105 may include at least one processing unit 202 and a system memory 204. Depending on the configuration and type of computing device, system memory 204 may comprise, but is not limited to, volatile (e.g. random access memory (RAM)), non-volatile (e.g. read-only memory (ROM)), flash memory, or any combination. System memory 204 may include operating system 205, one or more programming modules 206, and may include test results data 207. Operating system 205, for example, may be suitable for controlling server computing device 105's operation. In one embodiment, programming modules 206 may include a failure tagging programming module 220. Furthermore, embodiments of the invention may be practiced in conjunction with a graphics library, other operating systems, or any other application program and is not limited to any particular application or system. This basic configuration is illustrated in FIG. 2 by those components within a dashed line 208.

Server computing device 105 may have additional features or functionality. For example, server computing device 105 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and nonvolatile, removable and non-removable media implemented in any method or technology for storage of information, such as computer readable instructions, data structures, program modules, or other data. System memory 204, removable storage 209, and non-removable storage 210 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by server computing device 105. Any such computer storage media may be part of server computing device 105. Server computing device 105 may also have input device(s) 212 such as a keyboard, a mouse, a pen, a sound input device, a touch input device, etc. Output device(s) 214 such as a display, speakers, a printer, etc. may also be included. The aforementioned devices are examples and others may be used.

Server computing device 105 may also contain a communication connection 216 that may allow server computing device 105 to communicate with tester computing devices 115, such as over network 110 in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, failure tagging programming module 220 may perform processes including, for example, one or more method 300's stages as described below. The aforementioned process is an example, and processing unit 202 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

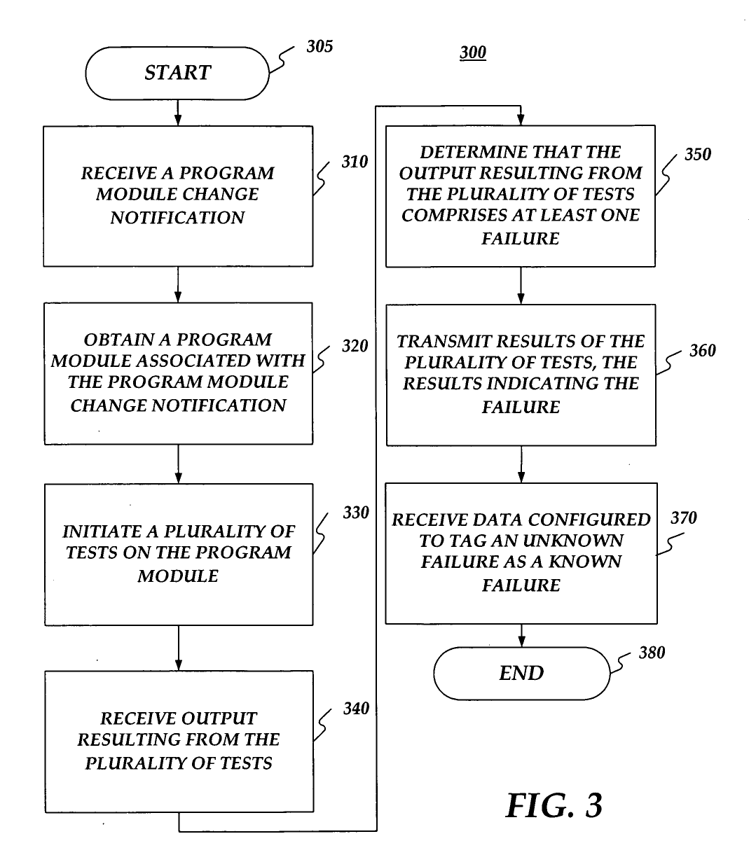

FIG. 3 is a flow chart setting forth the general stages involved in a method 300 consistent with an embodiment of the invention for providing failure tagging using computing device 105 of FIG. 2. Ways to implement the stages of method 300 will be described in greater detail below. Method 300 may begin at starting block 305 and proceed to stage 310 where computing device 105 may receive a program module change notification over network 110 from a user using user computing device 120. The program module change notification may be received in response to a change in programming code corresponding to program module 140. For example, the user may comprise a software developer. The software developer may make changes to programming code corresponding to program module 140. Program module 140 may comprise, but is not limited to, an application program. In order to determine if changes made by the software developer may have created problems in program module 140, the software developer may wish to have the now changed version of program module 140 tested. Consequently, the software developer may send the program module change notification over network 110 from user computing device 120 to computing device 105. The program module change notification may indicate that the software developer wants the programming code corresponding to program module 140 tested.

From stage 310, where computing device 105 receives the program module change notification, method 300 may advance to stage 320 where computing device 105 may obtain program module 140 associated with the program module change notification. For example, in response to receiving the program module change notification, computing device 105 may connect to user computing device 120 over network 110 and obtain program module 140.

Once computing device 105 obtains program module 140 associated with the program module change notification in stage 320, method 300 may continue to stage 330 where computing device 105 may initiate a plurality of tests on program module 140. For example, computing device 105 may send, over network 110, program module 140 to each of plurality of test computing devices 115. Furthermore, computing device 105 may send, over network 110, test scripts 135 to each of plurality of test computing devices 115. Sever computing device 105 may have a different set of test scripts for any type programming model to be tested. For example, if programming module 140 comprises a spreadsheet application, a first set of test scripts may be sent to test computing devices 115. If, however, programming module 140 comprises a word processing application, a second set of test scripts may be sent to test computing devices 115. Test scripts 135 may be designed to test one or more different aspects of programming module 140. For example, a test script may be designed to create and save a file, while another test script may be designed to simulate sending a document to a printer. In other words, test scripts 135 may comprise a set of programs configured to test one or more aspects of program module 140.

Another example may be that a singular test may be executed repeatedly on a program module to try to force a known, rare, failure to be encountered in order to hold the machine for investigation. In this example, the program module may not be altered by the developer because its issue has been present for a while and has been difficult to obtain a failure to debug.

When initiating the plurality of tests on program module 140, computing device 105 may send test scripts 135 to test computing device 125 and to test computing device 130. Accordingly, each of test computing device 125 and test computing device 130 may substantially concurrently run test scripts 135 on program module 140. In addition, each of test computing device 125 and test computing device 130 may repeatedly run test scripts 135 on program module 140. For example, test computing device 125 may run test scripts 135 300 times on program module 140 and test computing device 130 may run test scripts 135 200 on times program module 140.

After computing device 105 initiates the plurality of tests on program module 140 in stage 330, method 300 may proceed to stage 340 where computing device 105 may receive output resulting from the plurality of tests. For example, test computing device 125 and test computing device 130 may send output over network 110 to server computing device 105 indicating whether program module 140 passed or failed the tests.

From stage 340, where computing device 105 receives output resulting from the plurality of tests, method 300 may advance to stage 350 where computing device 105 may determine that the output resulting from the plurality of tests comprises at least one failure. The at least one failure may comprise an unknown failure or a known failure. A known failure may comprise a failure type that has been encountered before. For example, a failure may have been identified during a previous test. This previously identified failure may have been analyzed and “tagged” by a software developer who has taken on the responsibility to fix a programming bug that may have caused this particular failure. In this case, it may be important to note that the failure has been previously identified (i.e. tagged) and efforts are being made to fix it. Accordingly, the output received resulting from the plurality of tests may be compared to a database comprising known failures. This comparison may be made to determine if a similar failure exists in the database as a tagged failure.

In another embodiment, as the test logs a failure, the resulting failure may be processed to identify if it is a known failure. If the known failure has been set to hold the machine for debugging, then this action may be performed. If there is no action to perform at this point, then the test may be allowed to continue execution.

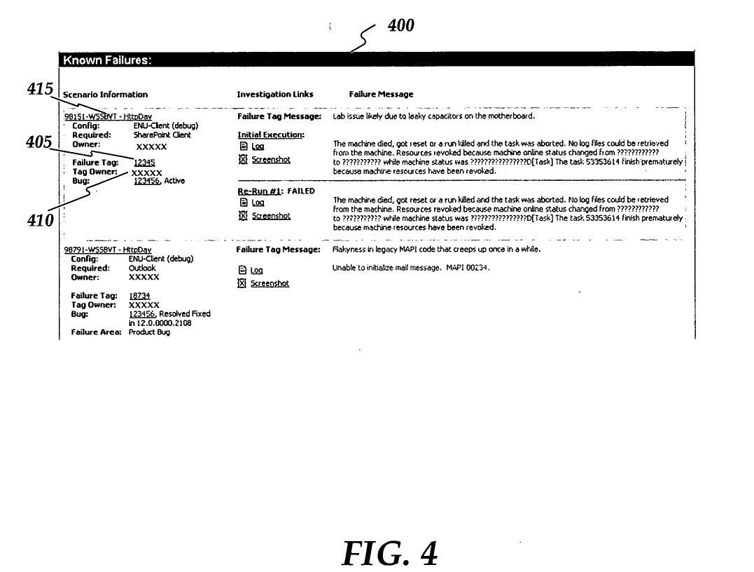

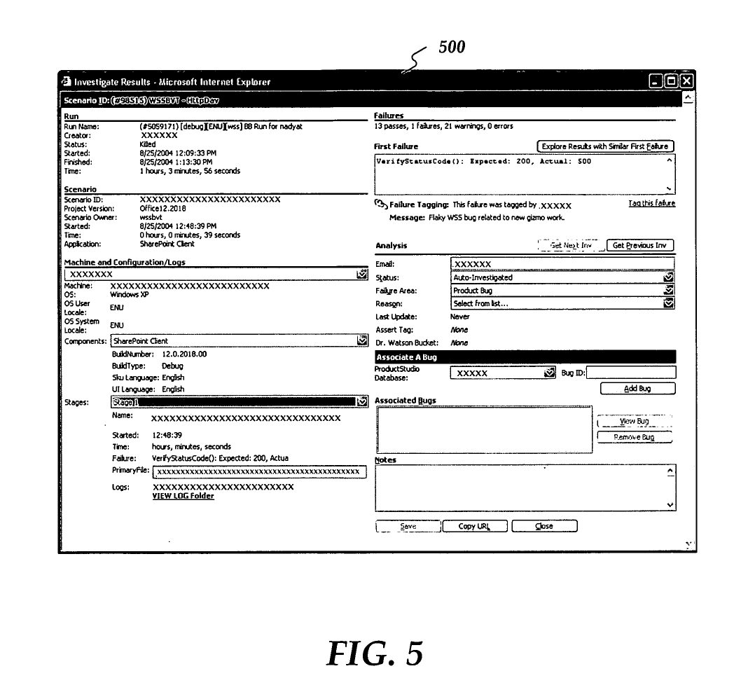

Once computing device 105 determines that the output resulting from the plurality of tests comprises at least one failure in stage 350, method 300 may continue to stage 360 where computing device 105 may transmit results of the plurality of tests. The results may indicate the failure. For example, server computing device 105 may send (e.g. via e-mail) user computing device 120 over network 110 the results. The results may indicate any situations in which program module 140 failed any of test scripts 135. Furthermore, the results may indicate if any of the failures are known or unknown. FIG. 4 shows a screen shot 400 illustrating sample results including known failures. For example, the results may indicate an identification number 405 corresponding to the known failure and a name 410 corresponding to a software developer who is working to correct a software bug believed to have caused the known failure. FIG. 5 shows a screen shot 500 illustrating additional details regarding the corresponding known failure from FIG. 4. For example, clicking on a scenario identification 415 may cause, screen shot 500 to appear.

After computing device 105 transmits the results of the plurality of tests in stage 360, method 300 may proceed to stage 370 where computing device 105 may receive data configured to tag an unknown failure as a known failure. For example, a user, comprising the software developer who made the aforementioned changes to the programming code corresponding to program module 140, may review the results received from computing device 105. Upon reviewing the results, the user may wish to “tag” an unknown failure shown in the results. For example, the user may determine that the unknown failure was caused by the aforementioned changes to the programming code corresponding to program module 140 that the software developer made. Consequently, the software developer may take ownership of fixing a defect in the programming code corresponding to program module 140 that may have caused the unknown failure. Accordingly, the software developer may provide to computing device 105, data configured to tag the unknown failure as a known failure. The data may associate the software developer tagging the unknown failure with the known failure. Computing device 105 may receive the data configured to tag the unknown failure as a known failure. In addition, computing device 105 may tag the unknown failure as a known failure based upon the received data.

Moreover, computing device 105 may configure the tag to expire after a predetermined amount of time. For example, the software developer associated with the tag as described above may fix a bug in the program module 140 that may have caused the unknown failure now tagged as a known failure. When this tagged failure is encountered again in any subsequent testing, the tag may be identified as a known (i.e. tagged) failure. However, if for any reason the software developer does not fix the bug, the tag may expire after the predetermined amount of time passes. After the tag expires, and if the failure associated with this expired tag is encountered again in any subsequent testing, the tag will be identified as an unknown failure. Once computing device 105 receives the data configured to tag an unknown failure as a known failure in stage 370, method 300 may then end at stage 380.

Consistent with another embodiment of the invention, computing device 105 may receive a request to stop one of plurality of test computing devices 115 on a failure when the one of the plurality of computers encounters the failure. The request may identify the failure. For example, as described above with respect to stage 370, the software developer may take ownership of fixing a bug in the programming code corresponding to program module 140 that may have caused an unknown failure the software developer subsequently tagged. In an effort to fix the aforementioned bug, the software developer wishing to fix the bug may want to have the computing device (or devices) within plurality of test computing devices 115 to stop when the failure associated with the bug is encountered.

After receiving the request, computing device 105 may transmit program module 140 to plurality of test computing devices 115 configured to run tests on program module 140. Subsequently, computing device 105 may stop one of the plurality of test computing devices 115 on the failure when the one of the plurality of test computing devices 115 encounters the failure identified by the request. After the one of the plurality of test computing devices 115 is stopped, computing device 105 may transmit a notice to the software developer. The notice may be configured to indicate, for example, that the one (or more) of the plurality of test computing devices 115 encountered the failure identified by the request, that the one (or more) of the plurality of test computing devices 115 is being held for the software developer, and information identifying the one of the plurality of test computing devices 115. As a result, the software developer may then go to the laboratory where the one of the plurality of test computing devices 115 is located. The user may then study or investigate the state of the one of the plurality of test computing devices 115 stopped in order to fix the aforementioned bug.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A computer-readable medium which stores a set of instructions which when executed performs a method for providing failure tagging, the method executed by the set of instructions comprising:
initiating a plurality of tests on a program module;
receiving output resulting from the plurality of tests;
determining that the output resulting from the plurality of tests comprises at least one failure, the at least one failure comprising one of an unknown failure and a known failure; and
transmitting results of the plurality of tests, the results indicating the failure.

2. The computer-readable medium of claim 1, further comprising receiving a program module change notification.

3. The computer-readable medium of claim 2, wherein receiving the program module change notification comprises receiving the program module change notification in response to a change in programming code corresponding to the program module.

4. The computer-readable medium of claim 2, further comprising obtaining the program module associated with the program module change notification.

5. The computer-readable medium of claim 2, wherein determining that the output resulting from the plurality of tests comprises the at least one failure, the at least one failure comprising one of the unknown failure and the known failure further comprises comparing the at least one failure to a database to determine if the at least one failure exists in database as a tagged failure, wherein, if the at least one failure exists in database as the tagged failure, marking the failure as known.

6. The computer-readable medium of claim 2, wherein initiating the plurality of tests on the program module comprises:
transmitting the program module to a first number of computers; and
running a second number of tests on the first number of computers.

7. The computer-readable medium of claim 6, further comprising transmitting at least one test script to the first number of computers, the at least one test script comprising testing code configured to provide the plurality of tests when executed.

8. The computer-readable medium of claim 6, wherein transmitting the program module to the first number of computers comprises transmitting the program module to the first number of computers having at least one of different microprocessors and different processing speeds.

9. The computer-readable medium of claim 6, further comprising:
receiving data configured to tag an unknown failure as a known failure; and
tagging the unknown failure as a known failure based upon the received data.

10. The computer-readable medium of claim 9, wherein tagging the unknown failure as a known failure based upon the received data further comprises tagging the unknown failure as a known failure based upon the received data wherein a tag associated with tagging the unknown failure is configured to expire after a predetermined amount of time.

11. A system for providing failure tagging, the system comprising:
a memory storage; and
a processing unit coupled to the memory storage, wherein the processing unit is operative to:
receive a request to stop a one of a plurality of computers on a failure when the one of the plurality of computers encounters the failure, the request identifying the failure;
transmit a program module to the plurality of computers configured to run tests on the program module; and
stop the one of the plurality of computers on the failure when the one of the plurality of computers encounters the failure identified by the request.

12. The system of claim 11, wherein the processing unit is further operative to transmit a notice to a user, the notice configured to indicate at least one of the following: that the one of the plurality of computers encountered the failure identified by the request, that the one of the plurality of computers is being held, and information identifying the one of the plurality of computers.

13. The system of claim 11, wherein the processing unit being operative to receive the request to stop the one of the plurality of computers on the failure comprises the processing unit being operative to the request to stop the one of the plurality of computers on the failure comprising a failure previously tagged as a known failure.

14. The system of claim 11, wherein the processing unit being operative to transmit the program module to the plurality of computers comprises the processing unit being operative to transmit the program module to the plurality of computers having at least one of different microprocessors and different processing speeds.

15. A method for providing failure tagging, the method comprising:
receiving a program module change notification in response to a change in programming code corresponding to a program module;
obtaining the program module associated with the program module change notification;
initiating a plurality of tests on the program module;
receiving output resulting from the plurality of tests;
determining that the output resulting from the plurality of tests comprises at least one failure, the at least one failure comprising one of an unknown failure and a known failure; and
transmitting results of the plurality of tests, the results indicating the failure.

16. The method of claim 15, wherein determining that the output resulting from the plurality of tests comprises the at least one failure, the at least one failure comprising one of the unknown failure and the known failure further comprises comparing the at least one failure to a database to determine if the at least one failure exists in the database as a tagged failure, wherein, if the at least one failure exists in the database as the tagged failure, marking the failure as known.

17. The method of claim 15, wherein initiating the plurality of tests on the program module comprises:
transmitting the program module to a first number of computers; and
running a second number of tests on the first number of computers.

18. The method of claim 17, further comprising transmitting at least one test script to the first number of computers, the at least one test script comprising testing code configured to provide the plurality of tests when executed.

19. The method of claim 17, wherein transmitting the program module to the first number of computers comprises transmitting the program module to the first number of computers having at least one of different microprocessors and different processing speeds.

20. The method of claim 17, further comprising:
receiving data configured to tag an unknown failure as a known failure; and
tagging the unknown failure as a known failure based upon the received data wherein a tag associated with tagging the unknown failure is configured to expire after a predetermined amount of time.
